(19) United States
(12) Patent Application Publication
(10) Pub. No.: US 2012/0302428 A1
(43) Pub. Date: Nov. 29, 2012

(54) CONTROLLED POROUS CATALYSTS TO PRODUCE HYDROGEN GAS BY DEHYDROGENATING ORGANIC COMPOUNDS

(76) Inventors: Esmaeel Naeemi, City of Lynnwood, WA (US); David O'Connor, City of North Bend, WA (US)

(21) Appl. No.: 13/442,719

(22) Filed: Apr. 9, 2012

Related U.S. Application Data
(60) Provisional application No. 61/472,956, filed on Apr. 7, 2011.

(51) Int. Cl. B01J 37/08; B01J 37/34

(52) U.S. Cl. 502/5; 502/300

(57) ABSTRACT

The current application discloses a method for producing a porous catalyst, the method comprising providing a powder of metal particles with a specific size; mixing into the powder of metal particles spacer spheres with a fixed diameter less than that of the metal particles; placing the metal-particle/spacing-sphere mixture in a ceramic container; heating the mixture in an oven, furnace or microwave oven to sinter the metal particles and fuse them to a solid matrix; and removing the spacing spheres either by solvolysis or pyrolysis.

### CROSS-REFERENCE TO RELATED APPLICATION

This application claims the benefit of Provisional Application No. 61/472,956, filed Apr. 7, 2011.

### TECHNICAL FIELD

The current application is related to dehydrogenation of organic compounds and, in particular, to a porous catalyst.

### BACKGROUND

Dehydrogenation of amine to nitrile is an endothermic process. There are two characteristics of this process: (1) the reverse reaction is more favored; and (2) the supplied heat for the endothermic process is high. This high heat can generate unwanted side reactions and decomposition of the nitrile.

### SUMMARY

The current application discloses a method for producing a porous catalyst, the method comprising providing a powder of metal particles with a specific size; mixing into the powder of metal particles spacer spheres with a fixed diameter less than that of the metal particles; placing the metal-particle/spacing-sphere mixture in a ceramic container; heating the mixture in an oven, furnace or microwave oven to sinter the metal particles and fuse them to a solid matrix; and removing the spacing spheres either by solvolysis or pyrolysis.

### BRIEF DESCRIPTION OF THE DRAWINGS

FIG. 1 shows a control-flow diagram for the disclosed method.

### DETAILED DESCRIPTION

To achieve the forward amine-to-nitrile dehydrogenation reaction, the generated hydrogen is removed from the reaction mixtures as fast as it is produced to minimize contact time and eliminate the reverse reaction. The pores in the catalyst provide a space for the generated hydrogen gas to expand and be transferred away from the catalyst. Also the pores provide more surface area and available catalyst active sites in order to facilitate a uniform reaction and lower the activation energy for the forward reaction.

### Preparation of the Catalyst

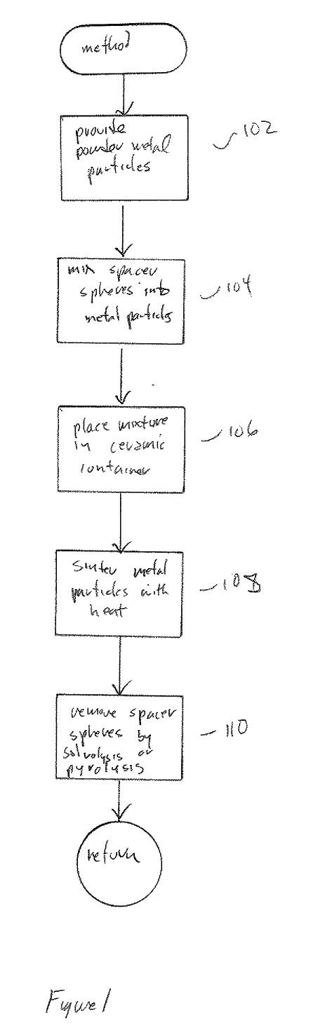

FIG. 1 shows a control-flow diagram for the disclosed method. Powder of metal particles with a specific size 102 anywhere from 10 um to 200 um is mixed with spacer spheres 104 with a fixed diameter less than the metal particle size to allow metal particles to touch each other in a fashion similar to center cubed crystals. The above mixture is placed in a ceramic container 106. The mixture is heated in an oven, furnace or microwave oven to sinter the metal particles and fuse them to a solid matrix 108. The spacer then is removed either by solvolysis or pyrolysis 110. The surface of this matrix is then oxidized to generate the active catalyst. The spacers used above can be made of organic polymers beads or inorganic salts such as sodium chloride and they are sieved to a uniform size.

Although the present invention has been described in terms of particular embodiments, it is not intended that the invention be limited to these embodiments. Modifications will be apparent to those skilled in the art. For example, cobalt metal particles may be employed, in one embodiment. Additional types of metal particles may be used in alternative embodiments.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for producing a porous catalyst, the method comprising:
providing a powder of metal particles with a specific size;
mixing into the powder of metal particles spacer spheres with a fixed diameter less than that of the metal particles;
placing the metal-particle/spacing-sphere mixture in a ceramic container;
heating the mixture in an oven, furnace or microwave oven to sinter the metal particles and fuse them to a solid matrix; and
removing the spacing spheres either by solvolysis or pyrolysis.
